(19) United States
(12) Patent Application Publication
(10) Pub. No.: US 2005/0240431 A1
(43) Pub. Date: Oct. 27, 2005

(54) Employment center

(76) Inventor: Milton S. Cotter, Arlington, TX (US)

Correspondence Address: Melvin J. Scolnick, 11041 Via San Remo, Boynton Beach, FL, 33437, US

(21) Appl. No.: 11/135,805

(22) Filed: May 25, 2005

Related U.S. Application Data
(63) Continuation-in-part of application No. 10/653,616, filed on Sep. 3, 2003.
(60) Provisional application No. 60/430,144, filed on Dec. 2, 2002.

(51) Int. Cl. G06F 17/60

(52) U.S. Cl. 705/1; 705/11

(57) ABSTRACT

A computerized method for screening job seekers and determining whether a job seeker is a qualified applicant for possible employment by an entity delivered through the web is disclosed. The method comprises attracting a pool of job seekers to a web site; enabling each job seeker to choose at least one job of interest to the job seeker; pre-screening each job seeker for each job of interest to the job seeker by having each job seeker respond to a series of computerized questions which can be scored; determining if the job seeker is a qualified applicant in that the job seeker meets the requirements of the uniform federal employment guidelines which define a job applicant; and obtaining additional information over the computer from job seekers.

### CROSS REFERENCES TO RELATED APPLICATIONS

This application is a continuation-in-part application of U.S. patent application Ser. No. 10/653, 616, filed Sep. 3, 2003 which is in turn a conversion of Provisional Application No. 60/430, 144, filed Dec. 2, 2002.

### BACKGROUND OF THE INVENTION

1. Field of the Invention

The present invention relates to a unique human resource computerized business process, delivered through software and/or the web, and more particularly to a computerized human resource business process that dramatically modernizes the entire human resource applicant attraction and screening process in any organization, and thereby eliminates the need for resume scanning, eliminates the need for the receipt of resumes by fax, email or paper, eliminates the need for the receipt of and dealing with job applications by faxing, emailing or paper, and also in general, eliminates any need for any resume tracking systems.

2. Description of Prior Developments

There are various known computer related systems useful for recruiting new employees. For example, there are systems which provide for a web site that gives a job applicant the ability to determine which jobs are available, where the jobs are located, and then the system permits the job applicant to submit a limited amount of data. These systems also permit the entity seeking new employees to view the information that has been provided by the job seekers. These known systems from a time, economical and efficiency standpoint, leave a great deal to be desired.

There are many specific features of the computer system for recruiting new employees in accordance with the features of the present invention which are not performed by known related systems. For example, known systems do not ask pre-screening questions which can be automatically scored and determine if a particular job seeker meets minimum requirements and is a qualified applicant for the job that is being filled. Known systems do not automatically advertise job openings and in combination offer a system where a job seeker can consider jobs from one or more potential employers, provide for aptitude and behavioral testing, background checking, or tax credit screening or gathering information for EEO and affirmative action related issues. Known systems in combination with the above do not provide for extensive information for new employees and current employees; and do not provide for many of the kind of administrative functions as provided by the present invention such as allowing authorized individuals from an employer organization who can access information about a job seeker only through secure codes and are able to compile and run hiring data reports.

A major critical feature of the present invention is the ability to differentiate an applicant as defined by uniform employment guidelines from an employment seeker. The prior art systems merely teach about early stage screening of a job seeker.

### SUMMARY OF THE PRESENT INVENTION

With there generally being in the business world a great deal of pressure to contain costs, lower costs, to accomplish more for less, and in general to be more efficient, the web based employment center in accordance with the features of the present invention is a basic approach to handling the entire job candidate attraction and applicant screening process through the web more efficiently, and in a manner that satisfies federal uniform employment guidelines. In accordance with the features of the present invention there is provided a computerized human resources business process for pre-screening job seekers and determining a job seeker's qualifications, and if the job seeker meets the minimum requirements for possible employment, that from a time, economy and efficiency standpoint is far superior to known methods and systems. The technology as defined by the present invention modifies, enlarges and enhances present methods and systems, and causes these computerized employment sites to be far more efficient, effective, and less time and labor consuming.

Specifically, there is provided by the features of the present invention a computerized method for screening job seekers and determining whether a job seeker is a qualified applicant for possible employment by an entity, the method being delivered through software and/or the web, comprising the steps of attracting a pool of job seekers to a web site; enabling each job seeker to choose at least one job of interest to the job seeker from one or more potential jobs; pre-screening each job seeker for each job of interest to the job seeker by having each job seeker respond to a series of computerized questions which can be scored; determining if the job seeker is a qualified applicant in that the job seeker meets the requirements of the uniform federal employment guidelines which define a job applicant; and then obtaining additional information over the computer from the job seekers. The system that performs these method steps is hereinafter referred to as the employment center. The employment center can be in the form of an employer's freestanding site or as an attachment to an employer's over all web site.

The advantages of the present invention can be seen from both a job seeker's point of view and from the point of view of administrators or recruiters looking for job seekers who are qualified applicants, i.e. meet the requirements of the uniform federal employment guidelines which define a job applicant, and meet the minimum requirements of the job. When a job seeker employs the features of the present invention:
a. the job seeker has the ability to choose from one or a plurality of potential jobs (i.e. different employer's)
b. the job seeker employs a process that provides general information about the overall organization that has certain jobs available,
c. the job seeker has the ability to determine if the job seeker is a qualified applicant by meeting the uniform federal employment guidelines which define the term qualified “applicant”
d. the job seeker knows if the job seeker meets the overall minimum requirements for the job, and
e. the job seeker has the ability to search for jobs at all of a particular employer's locations, and to apply for the same or different jobs in multiple locations at once.

When the job seeker chooses one or more organization(s) (i.e. possible employers) which have one or more job openings, the job seeker would be able to read about the organization(s), choose job titles at the organization in which there are job openings, view information about particular jobs the job seeker is interested in, and then choose the option to apply to particular jobs. Thereafter, the job seeker can complete personal information as requested by answering prescreening questions related to the respective job to determine whether or not the job seeker has certain minimum qualifications for the job; i.e. if the job seeker obtains a sufficiently high enough score in answering the prescreening questions, the job seeker may meet certain minimum qualifications. If the job seeker is a qualified applicant, i.e. the applicant meets the requirements of the uniform federal employment guidelines which define a qualified applicant, the job seeker will be asked for additional information such as, complete a full job application online for the respective organization(s); attach a full resume to the online application; and complete any questions that are significant regarding requirements for the job such as licensing, education, experience, information that could result in a tax credit for the organization doing the hiring, planning for EEO or affirmative action reporting, and also complete any other data that would be completed in the entire application process. There are instances where the job seeker will not be a qualified applicant and yet the organization will want that job seeker to proceed with the employment center process and supply additional information. For example, this can happen when the job seeker is the best applicant that is available for the job out of the pool of all the job seekers who applied for the job. If any particular testing is required for the job, that testing would then follow. Each and every item that an organization would want for any job opening that would normally be handled on paper would be completed by the job seeker totally on the web. Job seekers would be thanked for applying for the job and then would sign off. Job seekers would also have the opportunity to come back and update data.

Recruiters, hiring managers or human resource administrators within an organization can enter the administration section of the job opening site under a specific organization in certain job categories and see what job seekers have applied for certain jobs, or review the entire job seeker database in a particular job category for all the organizations having this job opening. Under the Administration section, a recruiter for example, would open a file that shows, under a job category, for example, the job seeker's last name, first name, date and time of application. Also the file would then reflect the prescreening questions (which can also help determine whether the job seeker is really a qualified applicant or not) and the job seeker's score on the prescreening questions (telling the recruiter which job seekers can be key candidates for the job). After reviewing this data, if the recruiting manager is really interested in a job seeker, the recruiter is able to open applications, a resume and/or any and all other data about the job seeker they choose. At this juncture, we have now completed all the application data on a job seeker and/or job applicant in a paperless manner; we have the ability to store any information about the candidate in various categories electronically, retrieve the information whenever the recruiter wants the information, conduct a job search by candidate name or social security number or affirmative action data, and also compile reports from any of the data. In this recruiting process there is no longer the need for any paper files since any of the data collected during the recruiting process can be printed out from the computer at any moment in time or exported into a major system within the entity that uses the employment screening process in accordance with the features of the present invention. Thus, the present invention provides an entire electronic process of record taking and record keeping that abolishes all the paper, meets Federal and State legal standards and requirements, is a non-discriminatory process for hiring and candidate selection, defines legally which of the job seekers is a qualified applicant in accordance with a legal definition of this term, maintains legal record keeping meeting state and federal laws, is tremendously economical and most importantly, helps pick the right person for the job. The Employment Center of the present invention keeps the employer, i.e. the user of the Employment Center with regard to record keeping, compliant with the Office of Federal Contract Compliance (OFCC) standards.

### BRIEF DESCRIPTION OF THE DRAWINGS

The accompanying drawings, which are incorporated in and constitute a part of the specification, illustrate specific embodiments of the invention and, together with the description, serve to explain the principles of the invention.

FIG. 1 is a flow chart depicting the various alternate process steps that can be taken by a job seeker in using the employment center features in accordance with various embodiments of the present invention;

FIG. 1A is a flow chart depicting various process steps following the steps of FIG. 1 which occur after the hiring of the job seeker;

FIG. 2 is a flow chart depicting an embodiment of the attraction, screening and qualifying process as performed by a job seeker in accordance with an embodiment of the present invention;

FIG. 2A is a flow chart depicting further specific examples of the attraction, screening and qualifying process as illustrated in FIG. 2;

FIG. 3 is a flow chart depicting various alternate process steps that can be taken by a human resource assistant or recruiter when using the employment center features in accordance with an embodiment of the present invention;

FIG. 4 is a flow chart depicting an alternate embodiment of the employment center relating to information for a new employee or a current employee;

FIG. 4A is a flow chart depicting a further embodiment of the employment center relating to information for a new employee or current employee;

FIG. 5 is a flow chart depicting an alternate embodiment illustrating the site administration segment of the employment center; and

FIG. 5A is a flow chart depicting a further embodiment of the site administration information of the employment center.

### DETAILED DESCRIPTION OF THE PREFERRED EMBODIMENTS

Employers first need a pool of applicants from which to select possible job candidates. The employment center, in accordance with the features of the present invention, allows employers to develop a pool of applicants utilizing many different sources. Employers may utilize any one of a plurality of sources to drive applicants to the employment center system to apply for a job, such as:
(i) Traditional Advertising—such as print Ads-newspaper ads ask applicants to apply via a website
   Cable TV ads—ask applicants to apply via a website
   Radio ads—ask applicants to apply via a website
   Job Board ads—ask applicants to apply via a website
(ii) Workforce Commission Listings—Workforce commission offices to post job openings for employers with information on how the applicant can apply via a website
(iii) Veteran Associations Listings—vetjobs.com and vfw.org post job openings with information on how individuals leaving the military may apply for openings via a website
(iv) Outplacement Firms—major outplacement firms post job openings with information on how individuals may apply for openings via a website
(v) Trade Schools—trade schools post job openings with information on how individuals may apply for openings via a website
(vi) College/University Posting—colleges/universities post job openings in their career centers with information on how individuals may apply for openings via a website
(vii) Subsidized Housing—Federal and state subsidized housing agencies post job openings with information on how individuals may apply for openings via a website
(viii) Employer On-Site Posting—employers may post the website information for applying on site

The employment center concept in accordance with the features of the present invention, operates in two modes: one mode is for individual's seeking employment with an employer (hereinafter referred to as “Job Seekers”), and one mode is for employees of the organization whose responsibilities include sourcing and screening job candidates (hereinafter referred to as “Administrators” or “Recruiters”).

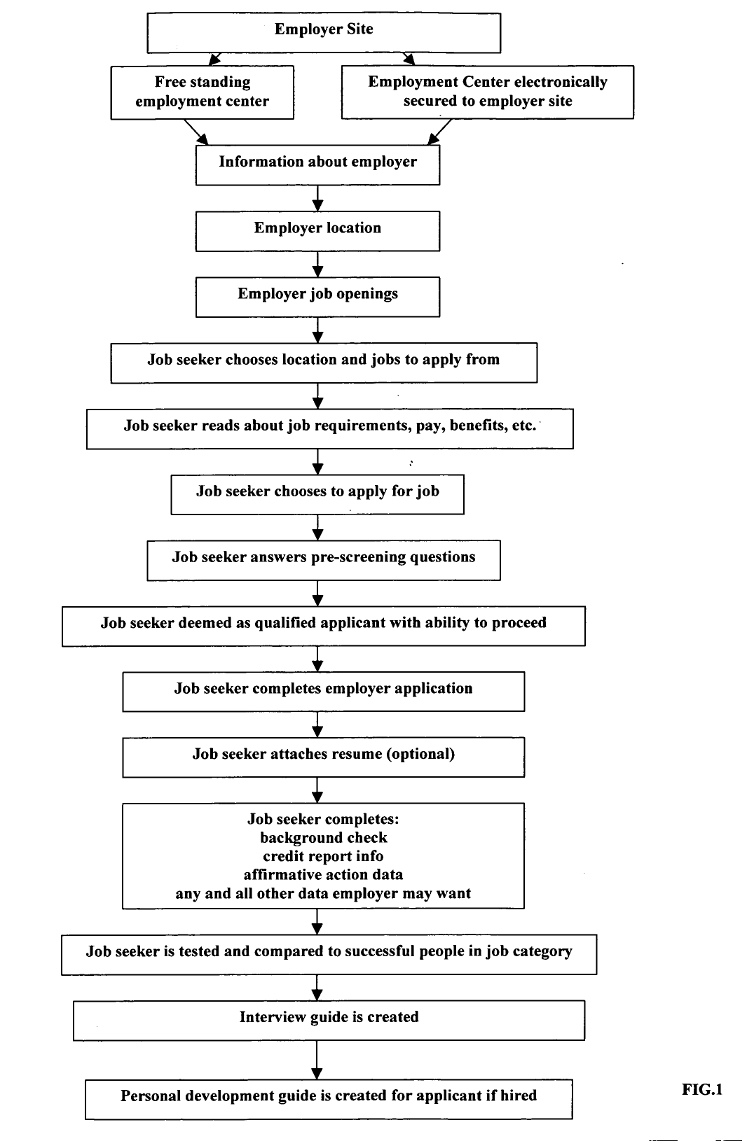

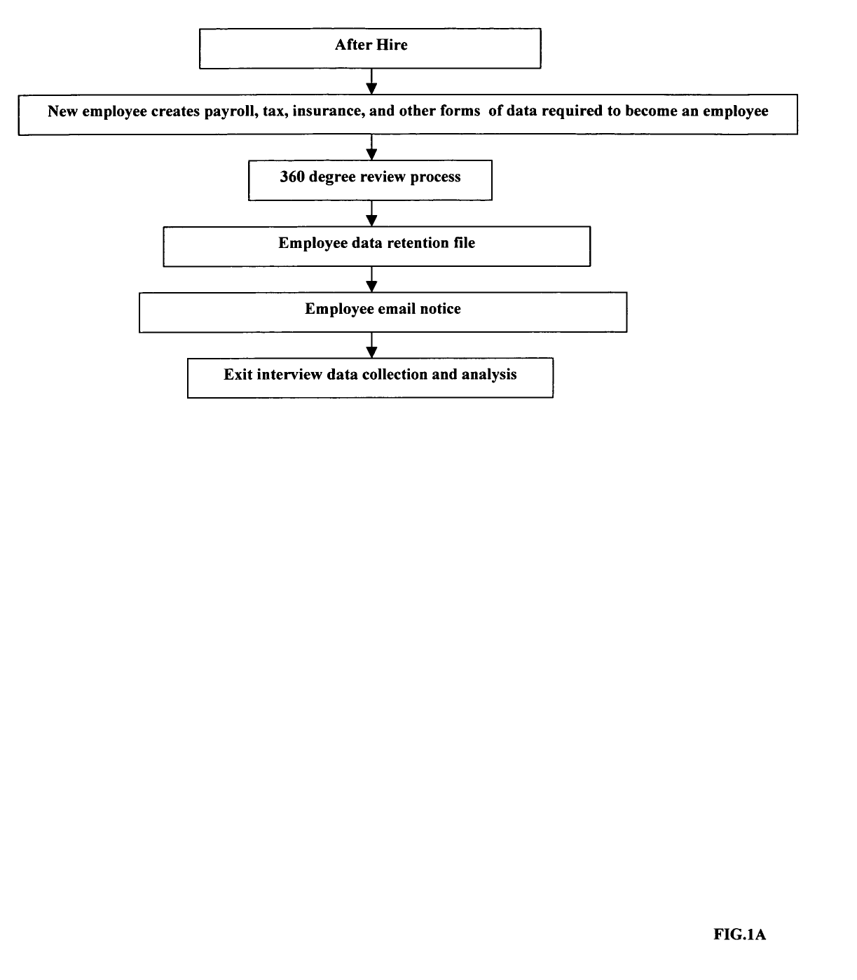

The first mode of operation, of the employment center, basically begins by providing information about the employer for job seekers (see FIG. 1). In this mode, the employment center provides access wherein job seekers:
(i) Can learn about the employer which has the job opportunities, the benefits of working for the employer and the specific job(s) available within the employer's organization.
(ii) Can select location(s) for which to apply for a job.
(iii) Can select job openings for which to apply.
(iv) Can answer the employer's initial pre-screening questions online, which determine the job seeker's basic qualifications for the job and help determine if the job seeker has the minimum qualifications for the job and can assist in determining if the job seeker is a qualified applicant.
(v) Can complete the employer's employment application online and attach a resume.
(vi) Can complete pre-employment testing of various kinds online.
(vii) Can complete data for affirmative action planning and EEO filings online.
(viii) Can complete data for background and credit checking online.

Since the job seeker will be a qualified applicant only if the job seeker meets the definition of a qualified applicant as in the uniform federal employment guidelines, EEO, and affirmative action filings will be easier to file.

After hiring the new employee, the new employee creates a file of information which is required by the employer for the new employee such as tax and insurance related information, etc. Thereafter, an employee retention file is created (see FIG. 1A). Regarding record keeping, the Employment Center in accordance with the features of the present invention keeps an employer compliant in accordance with the Office of Federal Contract Compliance (OFCC) standards.

The federal government, and particularly the Equal Employment Opportunity Commission (EEOC), the Department of Justice, the Department of Labor and the Office of Personnel Management issued guidelines on employee selection procedures as they relate to the internet and related technologies. In these guidelines, the EEOC stated that in order for an individual to be an applicant in the context of the internet and related electronic data processing technologies (i) an employer must have acted to fill a particular position; (ii) the individual job seeker followed the employer's standard procedures for submitting applications, and (iii) the individual job seeker has indicated an interest in the particular position. The EEOC and other government agencies currently have under consideration two further criteria, i.e. (iv) the individual Oob seeker) becomes an applicant if the job seeker meets the minimum requirements for the job, and (v) the individual (job seeker) must follow the employer's procedures for applying for a job. By completing an employer's prescreening questions online and scoring the job seeker's answers (also online) a fast determination can be made as to whether the job seeker meets the minimum qualification for the job.

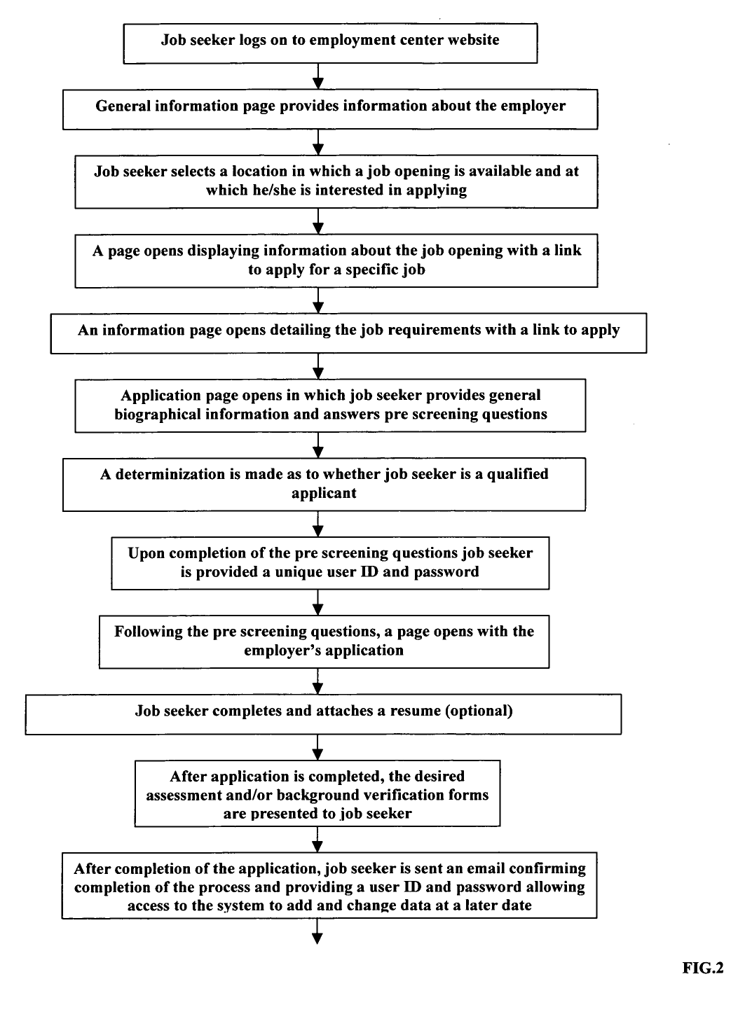

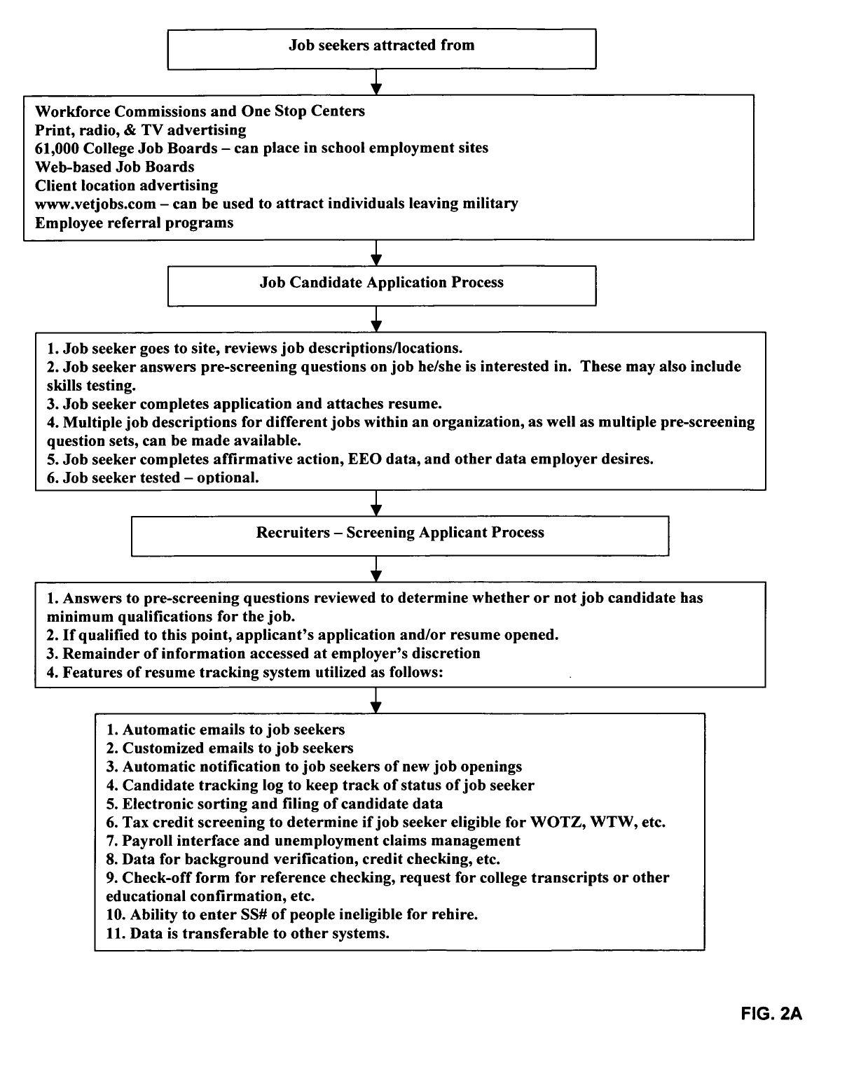

Illustrated in FIG. 2 is an embodiment of some of the specifics of the attraction, screening and qualifying process as performed by a job seeker in accordance with the features of the present invention. As illustrated, after the job seeker logs on to the web site for the employment center, the job seeker:
(i) Can learn about the employer, the various benefits that exist by working for the employer and the various jobs that are currently available at the employer.
(ii) Can choose the one or more locations for which to apply for a job.
(iii) Can choose the one or more job openings for which to apply.
(iv) Can complete the employer's basic pre-screening questions online. It is the answers to these questions (i.e. the score) that will determine if the job seeker meets the minimum requirements for the job and this will help determine who is a qualified applicant. It is the answers that differentiate job seekers who qualify from those that do not. Although in many cases the job seeker will not go any further if not determined to be a qualified applicant, this is not always the case. For example, there are times when the employer may want to select the best available candidate, for a particular job, and the best available candidate may not be a qualified applicant.
(v) Can complete additional significant data such as affirmative action and EEO related data.
(vi) Can complete the employer's employment application online and also attach the job seeker's resume to the application electronically.
(vii) Can complete pre-employment testing online and be compared to successful people in that job, e.g. compared to high performers in that particular job category.
(viii) Can enter various types of information online relating to background and credit checks, information that could lead to a tax credit for the company, confirmation of licensing and certifications, etc.

Whereas, the human resource administrator or recruiter can:
(i) Enter the site with special codes allowing the recruiter access for his/her area of geographical recruiting responsibility.
(ii) Always have an available pool of job seekers.
(iii) Access job seekers that are available by location(s) and/or jobs.
(iv) Review job seekers' ratings as derived by answers to the employer's basic prescreening questions and the answers themselves.
(v) View completed employer job applications online along with any attached resume.
(vi) Access the test results of job seekers.
(vii) Retain job seeker data in a centralized differentiating file place for ease of, for example, required EEO and other reporting data.
(viii) Maintain electronic files which can be sorted by groups or exported into the company HR system.
(ix) Collect affirmative action data and retain it for reporting purposes.
(x) Have all the features of a resume tracking system, such as:
   Automatic emails to job seekers who have not completed the entire application process;
   Automatic emails to job seekers thanking them for applying and/or allowing them to proceed on with the application process or stopping those who are not qualified applicants;
   The ability to create an email to a specific job seeker advising them to come in for an interview or whatever the hiring manager or recruiter would like to convey;
   The ability for the hiring manager or recruiter to email information to any of the job seekers;
   Job seeker tracking log to keep track of the status of the job seeker.

A combination of further specific examples of the attraction, screening and qualifying process is illustrated in FIG. 2A.

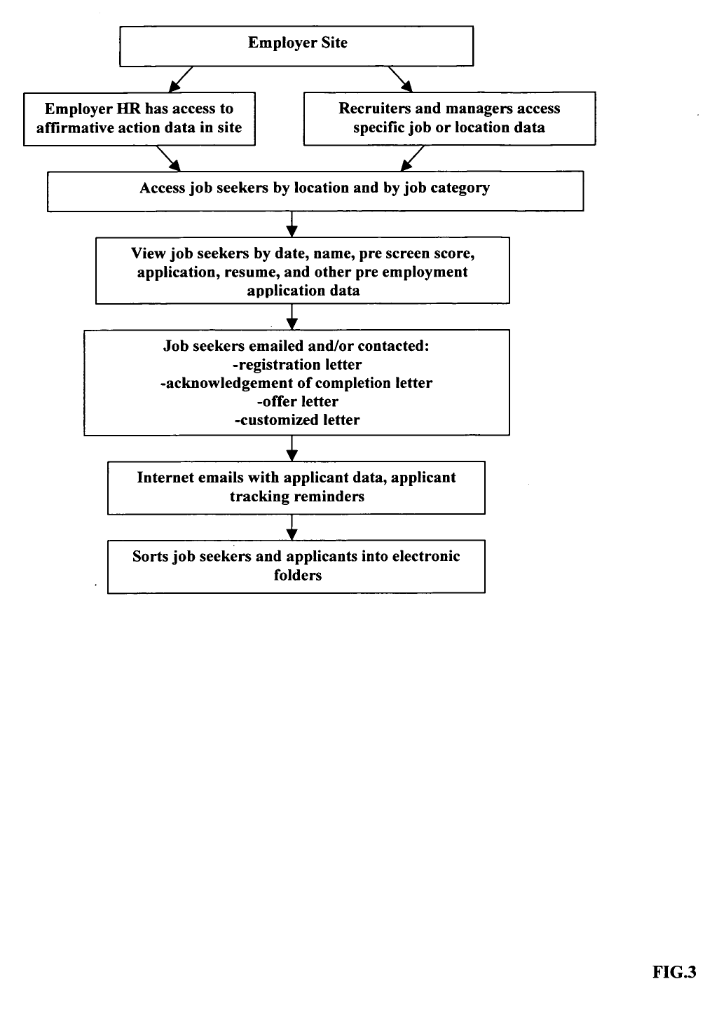

The second mode of operation of the employment center provides the employer administrator or recruiter, with access to the information relating to each job seeker that is gathered in the first mode of operation (see FIG. 3). In the second mode, the employment center provides access where employer administrators:
(i) Can enter the secure employment center data storage site with secure codes.
(ii) Can access job seeker data by one of two criteria:
   Location(s)
   Job(s)
(iii) Can review the job qualification rating given to each job seeker based on answers to the pre-screening questions, as well as the specific answers to the questions.
(iv) Can view each job seeker's completed application online and attached resumes.
(v) Can access each job seeker's pre-employment test results.
(vi) Can retrieve and move job seeker data to e-files at another location.

Specific input functions of the employment center, in accordance with the features of the present invention, are as follows:
(i) Provides information about the employer to the job seeker.
(ii) Allows the job seeker to choose an employer location(s) to apply for a job.
(iii) Allows the job seeker to choose an employer job(s) to apply for.
(iv) Allows the job seeker to read about job requirements, pay standards, benefits, etc.
(v) Allows the job seeker to complete pre-screening questions.
(vi) Allows the job seeker to complete employer application.
(vii) Allows the job seeker to attach resume.
(viii) Allows the job seeker to be tested.
(ix) Allows the job seeker to complete such other miscellaneous tests, forms or input data as the employer may require.

Specific data collection functions of the employment center, in accordance with the features of the present invention, are as follows.
(i) Complete applicant data file obtained online, with file data maintained electronically.
(ii) Complete data file is comprised of:
   Answers to employer's pre-screening questions.
   Employer's application completed online.
   Job seeker resume.
   Job seeker test results.
(iii) EEO; affirmative action and other data.
(iv) Collect data related to background and credit checks.

Specific output functions of employment center, in accordance with the features of the present invention, are as follows:
(i) Allows review of all of the job seeker's data in a comprehensive applicant data file.
(ii) Allows transfer of data to other systems.
(iii) Allows transfer of job seeker data to sub-files in the employment center.
(iv) Allows printing of data.

Regarding record keeping in general, the Employment Center keeps an employer complaint with the Office of Federal Contract Compliance (OFCC) standards. This is a unique feature of the Employment Center in accordance with the features of the present invention.

Generally speaking, the employment center site in accordance with the features and embodiments as described herein must be a stand alone site written in HTML, VB Script, Java Script and/or such languages as appropriate, and with a separate database (such as Access or SQL, but not limited to said databases). The program must run on Microsoft Windows NT, UNIX, Windows 2000 or such other operating systems as may be derived in the future.

Regarding the specifications for the job seeker functions, in accordance with the features of the present invention, they include: First, designing a site opening page to provide general employer information with a link to a job or career center page. Thereafter, designing a job or career center page to provide general information about opportunities related to working for the employer with link to location(s) page. The location page opens and lists locations for a job applicant to choose from to apply for a job, then linking to a jobs page. Jobs page opens to display the job openings within the employer, and allows job seekers to choose the job(s) for which they wish to apply. Upon choosing job(s) to apply for, a link to the next page opens which may list any or all of the following, but not limited to, job description, pay, benefits, job requirements, required education, skills, expertise, etc. A link is provided to a page in which the job seeker is asked a series of prescreening questions (such as first name, last name, home and other phone numbers, email address, social security number, and present address. Thereafter, the job seeker can be requested to enter a password of choice that is at least, for example, four characters, with a maximum of, for example, eight characters. This password can be used in conjunction with the job seeker ID as supplied later to enable the job seeker to access his/her application at a later time.)

For a sales job in the telecommunications industry, examples of the kind of prescreening questions that can be asked of a job seeker to determine if the job seeker meets the minimum qualifications for the job, and therefore may be a qualified applicant are as follows:
1. What period of time have you sold to top level executives?
   1 year or less
   1 to 2 years
   2 years or more
   Never
2. What period of time have you made B2B telephone calls to business mangers or executives?
   1 year or less
   1 to 2 years
   2 years or more
   Never
3. What period of time have you conducted personal one-on-one fact-finding (as the prelude to selling a product or service) interviews with business managers or executives?
   1 year or less
   1 to 2 years
   2 years or more
   Never
4. What period of time have you sold on a one-on-one basis, high ticket product or service to business managers or executives?
   1 year or less
   1 to 2 years
   2 years or more
   Never
5. What period of time have you sold a product or service where the major part of your plan consisted of commissions?
   1 year or less
   1 to 2 years
   2 years of more
   Never
6. What period of time have you earned $60,000 or more per year from sales you made on a base+commission or straight commission basis?
   1 year or less
   1 to 2 years
   2 years or more
   Never
7. What period of time have your earned $100,000 or more per year from sales you made on a base+commission or straight commission basis?
   1 year or less
   1 to 2 years
   2 years or more
   Never
8. What period of time have you conducted at least 3 to 4 one-on-one sales interviews on a daily basis, 5 days per week for at least 6 month?
   1 year or less
   1 to 2 years
   2 years or more
   Never
9. What period of time have you been assigned and achieved a sales quota for products or services you were responsible to sell that was at least $2,000,000 per year?
   1 year or less
   1 to 2 years
   2 years or more
   Never

### Use the Following Scenario for Questions 10 and 11:

Company XYZ has a Phone Bill that states they have 10 Local Phone Lines which cost $25 per month per line including all taxes and surcharges. They have $50 this month in Local Toll Charges, $75 of Intrastate calling, $25 of Interlate calling, $200 for 800 service charges and a separate Internet Bill of $300.
10. How much does this company owe for Outbound Toll Calls?
   $50
   $100
   $150
   $350
   None of the above
11. How much does this company have to pay each month just to have their local lines?
   $25
   $250
   $550
   $600
   $900
12. 800 Service can best be described as:?
   Inbound
   Outbound
   Paid for by the caller
   Paid for by the receiver
   None of the above
13. How many years of Direct Sales experience do you have selling voice Products? (Include only years where you sold LD, T1, etc. . . . not Hardware.)
   Never
   Less than 1 year
   1-2 years
   2-3 years
   3 or more
14. When was the most recent job you held that dealt with selling Voice products?
   Currently selling voice
   More than 1 year ago
   2-4 years ago
   5+ years ago
   Never sold voice, mostly hardware
15. Memorizing a sales presentation:
   Would take me a few days
   Might take a week
   Would take a couple of weeks
   I am not good at memorizing products
   Do not need to memorize since Presentations are usually done via Power Point
16. Company XYZ currently spends $1000 a month for a particular item. Vendor ABC comes in and sells the company the exact same item, but for only $700/month, replacing the $1000/mo item. Vendor ABC does this with no upfront costs including installation to Company XYZ. What is company XYZ's ROI?
   3 months
   $300 year
   1 year
   there is no ROI because the savings are immediate
   depends on how long Company XYZ keeps the new item
17. How many employers have you had in the past 6 years? (Keep in mind changing jobs within a company is one employer.)
   One
   Two
   Three
   Four
   Five or more
18. My experience is best summed up as:
   Telemarketing
   Project Management
   Wireless Phones
   Direct Sales
   Inside Sales
19. Whom have you spent your career selling to? (Mark all that apply.)
   Small to medium sized businesses
   Medium to large accounts
   Only Fortune 500
   Carriers
   My experience is mostly in project management not selling

Thereafter, at this juncture, the job seeker can be requested to attach electronically a resume which can be accepted in formats such as Adobe Acrobat (.PDF), Microsoft Word (.DOC), Microsoft Rich Text (.RTF), HTML or standard ASCII text format (.TXT).

Thereafter a program is provided to grade answers to prescreening questions to provide a numerical score based upon the correct prescreening answers. It is this numerical score that will determine if the job seeker meets the minimum requirements for the job and therefore may be a qualified applicant.

Once prescreening questions and answers are submitted to the server, information is written to the database and the employer employment application is then presented to the job seeker. Specific fields can be set to be required entry through client side scripting. These fields are required to be answered before the application can be submitted to the server. Once the server receives this information from the application, it is appended to the job seeker's unique record ID.

After this process is completed, the job seeker can be presented with an appropriate assessment test to be completed online that has been set for that specific job. Once submitted, this information is added to the database with the job seeker's unique ID. This activity generally concludes the job seeker's interaction in regards to this specific job with the employer. The program would then have the job seeker complete such other forms, tests and personal data as the company may require. (Job seeker data can be completed in any sequence, either as listed above or otherwise.)

Regarding the specification for the human resource administrator's or recruiter's functions in accordance with the features of the present invention; the program would provide access of the job seeker data as follows:
Employers may have multiple regions, each of which contain multiple cities. Employers may also have only one region with all cities listed under it. Cities may also require breakdown by zip code, map or telephone prefix.
Each employer region, city or part thereof has a unique log on code and password combination. When the administrator logs in, a drop down box appears which displays all of the region's cities and sub-segments thereof.
If a city has any unviewed prescreens, the city will be highlighted in green and the number of unviewed (new) prescreens will be shown in (X) where X is the actual number. Prescreening questions by job seeker are scored and rated, displaying applicant name and date completed.
Once the administrator chooses a city or city segment, the next screen will display in a table (Excel-like Visual format). Data consists of name, date and time process started and completion status of each phase of the application process and optionally, may include job seeker names on the prescreening question answers and as one application process or any part thereof.
Completion status shows as “Completed” if the process is completed, but not viewed by the administrator. “Viewed,” indicates the administrator has reviewed the particular process. A blank gray area indicates the applicant has not completed the process. “Available” indicates the process is available to be viewed.
Another table call allows an applicant record to be deleted. The record is not actually deleted, but just flagged as deleted. This “delete” call will display “<24 hrs” if the job seeker has not finished the complete application process and job seeker started it less than 24 hours prior to current time. Once the applicant completes the entire application process or 24 hours have expired, the delete function will be active.
Prescreen scores can be reviewed prior to viewing the questions and answers. The administrator will see the # of correct responses the applicant had on the prescreen questions and any rating thereto. The administrator can then choose to view the actual prescreen questions and answers.
The program for each application process (i.e. personal data, prescreen questions and answers, completed application with resume or testing) to be viewed in order. Also program to optionally change this sequence should a company choose.
A program is provided to operate in the following sequence: Once the prescreen is viewed, then the application can be viewed. Once application is viewed, then assessment can be viewed. Program provided to optionally alter sequence.
A program is provided to capture the data and time the administrator first views one of the processes; that date and time will be shared in the applicant's unique record ID.
A program is provided to allow export of data by the employer company to any other system of the employer's choice.
A program is provided to allow employer to print out any or all data entered by the job seeker.
A program is provided to allow employer to enter other job seeker data to comply with state, federal and other reporting requirements.
A program is provided to allow employer personnel to create sub-set files for (but not limited to):
   Qualified
   Not Qualified
   Hired
   Not Hired
   Pending Interview
   Pending

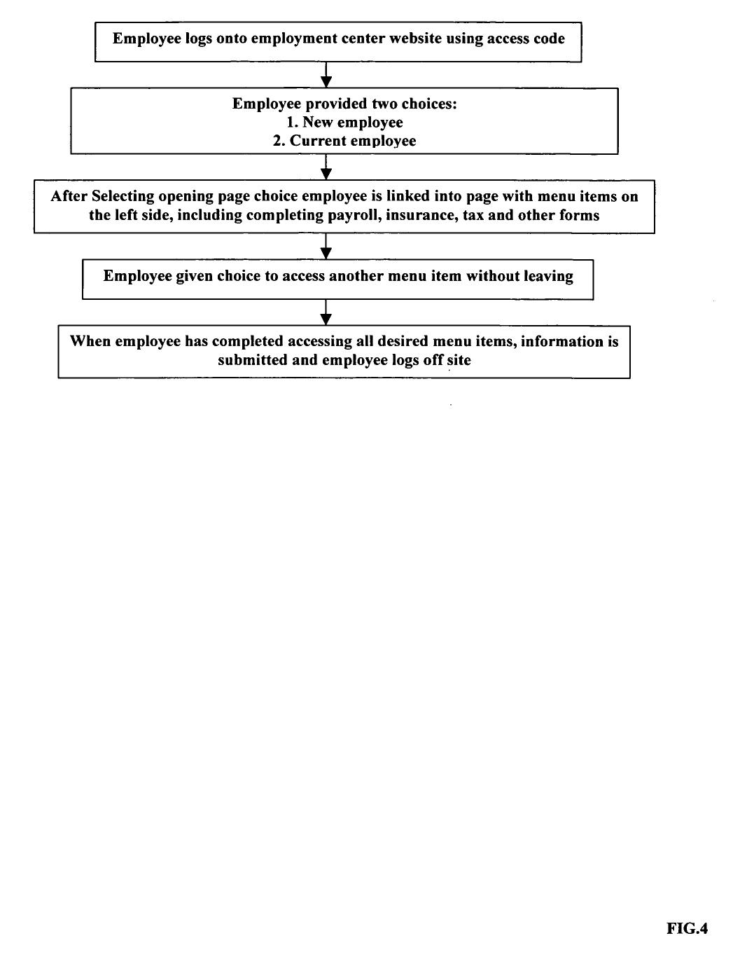

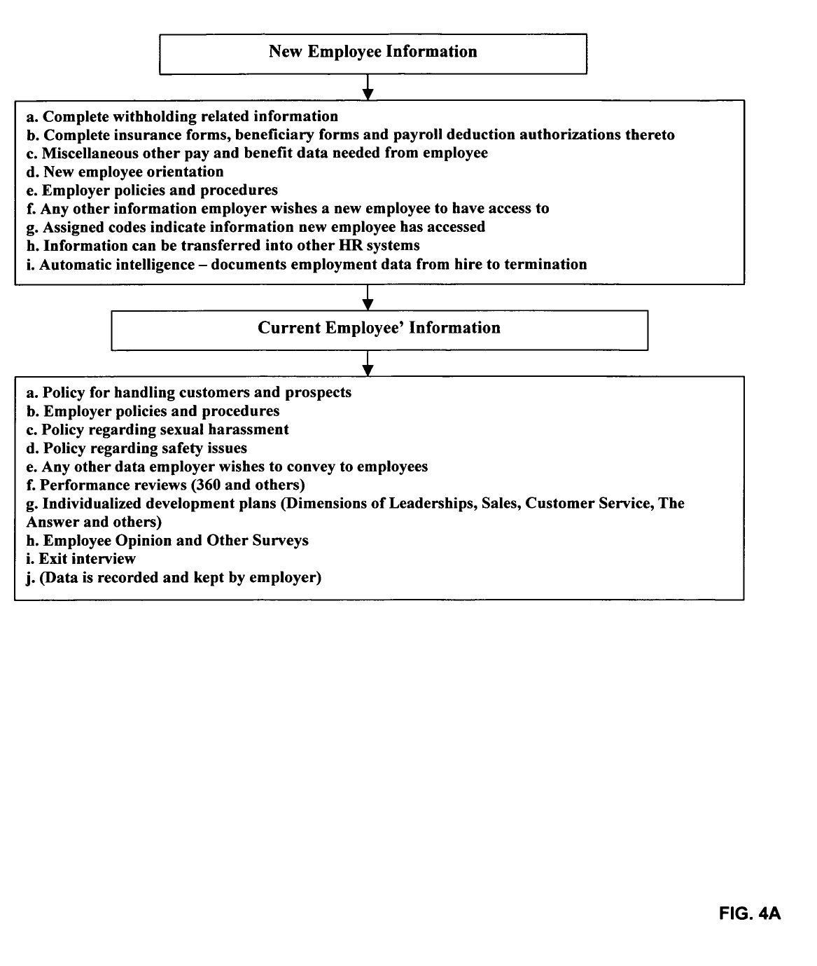

An alternate embodiment of the employment center is available to an employer (company) to house information the employer wants either a new employee or a current employee to know, such as policies, employer procedures, etc., as well as information the employer needs to know about the employee, i.e. payroll deduction information, etc. This part of the employment center also obtains and retains information from new and current employees regarding insurance, benefits, and any other data necessary to maintain employee personnel files. See FIG. 4.

For the employer, this embodiment tremendously reduces the massive amount of paper files which must be kept by the employer. Since all of this information is accessible only by special code, it also increases security of all of such information, thus helping to prevent the theft of an employee's identity, prevent tampering with employee records, etc. For the employee, there are also tremendous advantages. With great ease, the employee, at home or at work, can access their records via an assigned code, can make changes in insurance information, beneficiary information, etc. Furthermore, if the employee wishes to look up an employer policy or read about a particular aspect of insurance, the employee only has to access those records via their employee code and review the information they need.

As stated, this embodiment is available to either a new or current employee of the employer. For new employees the opportunity is given to complete new hire related information that an employer requires to set that employee up for payroll related maters, insurance, benefits and all other data to go into the employee's personnel file. The employer has as an option to keep the employee's file electronically in the employment center or printed out and kept in the employee's paper personnel file or exported into the employer's major or HR computer system. The new employee is therefore given the option to:
(i) complete withholding related information;
(ii) complete insurance forms, beneficiary forms and payroll deduction authorizations;
(iii) complete any other pay and benefit data needed from employee;
(iv) obtain employee orientation manual related information;
(v) obtain employer policies and procedures; and
(vi) complete information such as a check-off form for reference checking, request for college transcripts or other educational confirmation, etc.

By an employer assigning a special code to each and every employee, the employer has a record that the employee has completed data required, has read, reviewed and also if desired, been tested on data presented to the new employee.

Current employees of the employer can obtain information regarding current employee's knowledge and understanding of various aspects of the employer and/or the employee's specific job, as well as records of training and development that was provided to the employee. An employee's exit interview related information upon departure from the employer can also be obtained.

Some specific examples of information that can be obtained by current employees are:
(i) policy for handling customers and potential new customers
(ii) employer policies and procedures
(iii) policy regarding sexual harassment, i.e., what constitutes sexual harassment, information relating to the employer's stand on such misconduct, etc.
(iv) policy regarding safety issues
(v) performance reviews
(vi) individualized development plans
(vii) employee opinion surveys and other surveys

Testing on the subject material is also an option with record retention by employee name and/or employee record number. This segment, in essence, is to maintain employee records in a paperless mode. It can also serve as a reference for employees, both new and old.

If the new employee option is selected, the web site opens into information and includes the functions available for new employees, including but not limited to, for example, entering W-2 form related information, completing payroll deduction authorization forms and other data, reading or reviewing employer policies and procedures, etc. The new employee selects functions that he/she desires to access. If the new employee chooses a function which requires new employee input data, the new employee submits such data. Once the information is submitted to the server, information is written to the database and the data is sorted into an individual employee file which is only accessible by special code. In discussing with the employer, specific fields are set to be required entry through employee side scripting, these fields are required to be answered before the employee's information can be submitted to the server. Once the server receives this information from the employee, it is appended to the employee's unique record ID.

If the current employee option is selected, the site opens into information and presents the functions available for current employees, including but not limited to reading and reviewing employer policies and procedures, reading and reviewing employer policy re: sexual harassment, reading and reviewing safety rules and regulations, reviewing how the employer wants their employees to deal with customers and potential customers, reviewing performance reviews, obtaining individual development plans, completing employee surveys, completing the exit interview, etc.

The employee selects the function that he/she desires to access. If the employee chooses a function which requires the employee to input data, the employee does so and submits the data. Once information is submitted to the server, information is written to the database and the data is sorted into an individual employee file which is only accessible by special code. Specific fields are set to be required entry through employee side scripting, these fields are required to be answered before the employee's information can be submitted to the server. Once the server receives this information from the employee, it is appended to the employee's unique record ID. Some additional embodiments of the new and current employee information is illustrated in FIG. 4A.

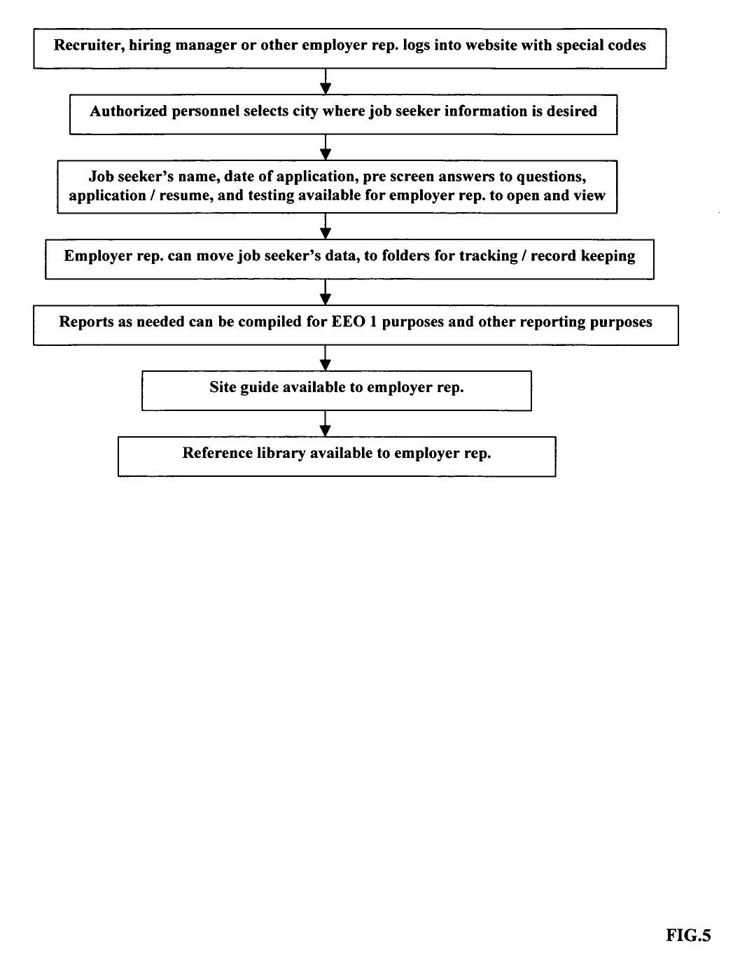

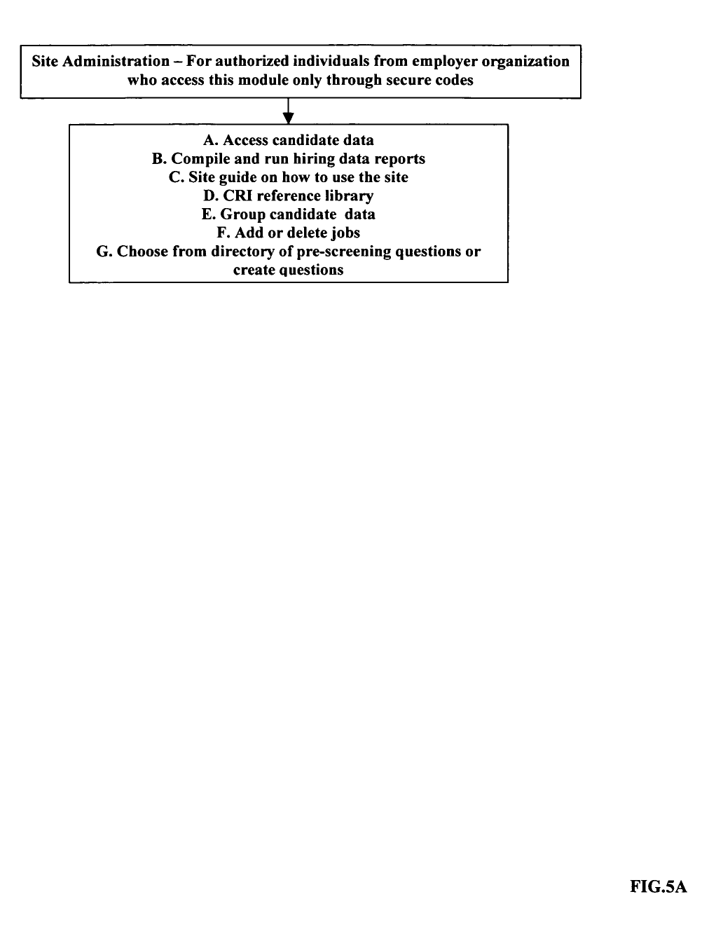

Another alternate embodiment of the employment center in accordance with the features of the present invention is what can best be described as the site administration segment of the employment center as illustrated in FIG. 5. Only authorized individuals from the employer organization who are provided secure codes can access any parts of or all data available in the system as determined by the employer and the codes assigned. In the administrative site of the employment center in accordance with the invention, the employer may, for example:
(i) Select the city in which job seekers are needed by the employer.
(ii) Access candidate data, i.e., who applied, date, time, answers and rating score on pre-screening questions, completed job application, job seeker attached resume, completed affirmative action data, any and all test data and any and all information desired by the employer for background checking, credit checking, drug testing and/or any and all other data that the employer may seek regarding any job seeker.
(iii) Compile and run other hiring data reports as job seeker data analysis.
(iv) Review a site guide as to how to use the site.
(v) Add or delete jobs.
(vi) Choose from a directory of pre-screening questions and answers, or employer can create their own custom prescreen questions and expected answers.
(vii) Employ a reference library as a resource.

Again, the program specifications to provide the administrator access to job seeker data includes the following features:
Employer may have multiple regions, each of which contain multiple cities. Employers may also have only one region with all cities listed under it. The cities may also require breakdown by zip code, or telephone prefix.
Each employer region, city or part thereof has a unique log on code and password combination. When the administrator logs in, a drop down box appears which displays all of the region's cities and sub-segments thereof.
If a city has any unviewed prescreens, the city will be highlighted in green and the number of unviewed (new) prescreens will be shown as (X) where X is the actual number. Prescreening questions completed by job seekers are scored and rated, applicant name and date completed is displayed.
Once the administrator chooses a city or city segment, the next screen will be displayed in a table format (i.e. Excel—like visual format). Data consists of name, date and time, process started and completion status of each phase of the application process and optionally may include job seeker rates on the prescreening questions/answers and as one application process or any part thereof.
Completion status shows as “completed” if the process is completed, but not viewed by the administrators. “Viewed,” indicates that the administrator has reviewed the particular process. A blank gray area indicates that the applicant has not completed that process. ‘Available’ indicates that the process is available to be viewed.
Another table cell allows an applicant record to be deleted. The record is not actually deleted, but just flagged as deleted. This “delete” cell will display “<24 hrs” and this means that the job seeker has not finished the complete job seeker process, and that the job seeker started it less than 24 hours prior to current time. Once they complete the entire application process or 24 hours has passed, the delete function will be active.
The prescreen questions and answers to the questions can be reviewed prior to a general viewing. The administrator will see the number of correct responses the job seeker had on the prescreen questions and any rating assigned thereto. The administrator can then choose to view the actual prescreen questions and answers.
The program for each application process (i.e. personal data, prescreen questions and answers, completed job application with resume and/or testing) to be viewed in order. Also, a program to optionally change this sequence can be used should an employer make such a choice. A program is employed which operates in the sequence that once the prescreen questions and answers are viewed, then the job application can be viewed. Once the job application is viewed, then the assessment can be viewed. A program can be created to optionally alter this sequence. A program can be used to capture the date and time the administrator first views one of the processes. That date and time will be stored in the job seeker's unique record ID. Various other programs can be used such as, for example, a program to allow the export of data by the employer to any other system of the company's choice, a program to allow the employer to print out any or all data entered by the job seeker, a program to allow the employer to enter other job seeker data to comply with state, federal and other reporting requirements, and a program to allow the employer personnel to create sub-set files for such items as, for example, “Qualified”—“Not Qualified”—“Hired”—“Not Hired”—“Pending interviews” and “Interviewed—Pending file. An additional embodiment of the flow chart for the site administration portion of the employment center in accordance with the features of the present invention is illustrated in FIG. 5A wherein site administration information is illustrated in detail.

While this invention has been described in conjunction with the exemplary embodiments outlined above, it is evident that many alternatives, modifications and variations will be apparent to those of ordinary skill in the art. Accordingly, the exemplary embodiments of the invention, as set forth above, are intended to be illustrative, and not limiting. Various changes may be made without departing from the spirit and scope of the invention.

1. A computerized method for screening job seekers and determining whether a job seeker is a qualified applicant for possible employment by an entity, the method being delivered through software and/or the web comprising the steps of:
(a) attracting a pool of job seekers to a web site;
(b) enabling each job seeker to choose at least one available job of interest;
(c) pre-screening each job seeker for each job of interest to the job seeker by having each job seeker respond to a series of computerized questions which can be scored;
(d) determining if a job seeker is a qualified applicant in that the job seeker meets the requirements of the uniform federal employment guidelines which define a job applicant; and
(e) obtaining additional information over the computer from job seekers

2. A method according to claim 1 wherein step (e) is only performed by those job seekers that have been classified as qualified applicants.

3. A method according to claim 1 further comprising the step of generating a computer response to each job seeker that becomes a qualified applicant after step (e).

4. A method according to claim 1 wherein step (b) enables a potential job seeker to read about the entity posting the job on the computer; the various geographical locations of the entity; and the various jobs which are available at each of the geographical locations.

5. A method according to claim 1 wherein step (b) enables each job seeker to choose from a plurality of potential employers.

6. A method according to claim 1 wherein step (e) includes having the applicant supply the information as requested in a formal job application.

7. A method according to claim 1 wherein step (e) includes electronically attaching the job seeker's resume to said job application.

8. A method according to claim 1 wherein step (e) includes having the job seeker supply affirmative action data.

9. A method according to claim 1 wherein step (e) includes conducting testing on said job seeker to help determine if said job seeker should be hired by said entity for a job.

10. A method according to claim 1 wherein step (e) includes obtaining information from the job seeker about licensing requirements for the job.

11. A method according to claim 1 wherein step (e) includes obtaining information relating to drug testing.

12. A method according to claim 1 wherein step (e) includes a criminal background check on the job seeker.

13. A method according to claim 9 wherein said testing relates to aptitude testing.

14. A method according to claim 9 wherein said testing relates to behavior testing.

15. A method according to claim 9 whereas incorrect responses to said testing are identified and results of testing are provided.

16. A method according to claim 1 wherein steps (a) through (e) are in the form of a program that is an enhancement to an existing Internet web site.

17. A method according to claim 1 wherein steps (a) through (e) are in the form of a new, freestanding web site.

18. A method according to claim 1 wherein steps (a) through (e) are performed by a job seeker who is seeking employment with said entity.

19. A method according to claim 1 wherein said job seeker performs step (a) or (b) to learn about said entity.

20. A method according to claim 1 wherein said job seeker performs step (a) or (b) to learn about the jobs that are available at said entity.

21. A method according to claim 1 wherein step (b) enables said job seeker to select at least one job location for which to apply.

22. A method according to claim 1 wherein step (b) enables said job seeker to select a plurality of job openings for which to apply.

23. A method according to claim 1 wherein said pre-screening questions of step (c) are specifically based on job description.

24. A method according to claim 1 wherein step (e) is conducted by a job seeker that does not have a sufficiently high score to be classified as a qualified applicant for that job.

25. A method according to claim 24 wherein for each job seeker that is not a qualified applicant after step (d), generating a computer letter to each such job seeker informing such job seeker that said job seeker is not qualified.

26. A method according to claim 1 wherein the questions of step (c) are scored to see if the job seeker has the minimum requirements for the job.

27. A method according to claim 1 wherein step (d) defines a job applicant existing when (i) an employer has acted to fill a particular position; (ii) the job seeker follows the employer's standard procedures for submitting applications, and (iii) the job seeker indicates an interest in the particular position.

28. A method according to claim 27 wherein step (d) further includes to fully define a job applicant (iv) when the job seeker meets the minimum requirements for the job, and (v) the job seeker must follow the employer's procedures for applying for a job.

29. A method according to claim 1 wherein said entity's record keeping is kept compliant with the Office of Federal Contract Compliance standards.
